(19) United States
(12) Patent Application Publication
(10) Pub. No.: US 2014/0129063 A1
(43) Pub. Date: May 8, 2014

(54) ADAPTING AN ENERGY STORAGE SYSTEM THERMAL CONDITIONING SETPOINT BASED ON HISTORICAL USAGE

(71) Applicant: GM GLOBAL TECHNOLOGY OPERATIONS LLC, Detroit, MI (US)

(72) Inventors: David Robert Clark, Royal Oak, MI (US); Charles A. Bezzina, Livonia, MI (US)

(73) Assignee: GM GLOBAL TECHNOLOGY OPERATIONS LLC, Detroit, MI (US)

(21) Appl. No.: 13/670,903

(22) Filed: Nov. 7, 2012

(51) Int. Cl. G06F 17/00

(52) U.S. Cl. CPC G06F 17/00
USPC 701/22

(57) ABSTRACT

A method of controlling a temperature of an energy storage system of an electric vehicle includes monitoring vehicle operating conditions over time, identifying historical vehicle operating trends from the monitored vehicle operating conditions, and adjusting a default thermal conditioning temperature setpoint for the energy storage system to define an adjusted thermal conditioning temperature setpoint. The default thermal conditioning temperature setpoint is adjusted based on the identified historical vehicle operating trends to optimize performance of the energy storage system for the historical vehicle operating trends. The energy storage system is heated and/or cooled to align an actual temperature of the energy storage system with the adjusted thermal conditioning temperature setpoint.

### TECHNICAL FIELD

The invention generally relates to a method of controlling a temperature of an energy storage system of a vehicle.

### BACKGROUND

Electrically powered vehicles, such as but not limited to fully electric plug-in vehicles, hybrid plug-in vehicles, or extended range electric vehicles, include an energy storage system, such as but not limited to a battery pack. The range that electrically powered vehicles may drive is important to operators, and is dependent upon the temperature of the energy storage system. A thermal conditioning system of the vehicle heats and/or cools the energy storage system to align an actual temperature of the energy storage system with a thermal conditioning temperature setpoint. The thermal conditioning temperature setpoint is based upon estimated vehicle usage conditions of an average or typical vehicle. Accordingly, the thermal conditioning temperature setpoint is the same for all geographic locations, all seasons, etc.

### SUMMARY

A method of controlling an electrically powered vehicle having an energy storage system is provided. The method includes monitoring vehicle operating conditions over time, and identifying historical vehicle operating trends from the monitored vehicle operating conditions. A default thermal conditioning temperature setpoint for the energy storage system is adjusted to define an adjusted thermal conditioning temperature setpoint. The default thermal conditioning temperature setpoint is adjusted based on the identified historical vehicle operating trends to optimize performance of the energy storage system for the historical vehicle operating trends.

A vehicle is also provided. The vehicle includes an energy storage system operable to store electrical energy, and a thermal conditioning system coupled to the energy storage system and operable to heat and cool the energy storage system. A control module is coupled to the thermal conditioning system, and is operable to control the thermal conditioning system. The control module is configured for monitoring vehicle operating conditions over time and identifying historical vehicle operating trends from the monitored vehicle operating conditions. The control module adjusts a default thermal conditioning temperature setpoint for the energy storage system to define an adjusted thermal conditioning temperature setpoint. The control module adjusts the default thermal conditioning temperature setpoint based on the identified historical vehicle operating trends to optimize performance of the energy storage system for the historical vehicle operating trends. The control module engages the thermal conditioning system to thermally condition the energy storage system to align an actual temperature of the energy storage system with the adjusted thermal conditioning temperature setpoint.

Accordingly, the default thermal conditioning temperature setpoint, which is a pre-defined value based on estimated vehicle usage conditions of an average or typical vehicle, is adjusted to define the adjusted thermal conditioning temperature setpoint, which is defined based on the actual vehicle operating conditions and trends of the current vehicle. Accordingly, the temperature of the energy storage system may be controlled to a temperature more appropriate for the actual operating conditions of the vehicle, thereby improving performance of the energy storage device and/or increasing the life of the energy storage device.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic plan view of an electrically powered vehicle showing an energy storage system and a thermal conditioning system for heating and/or cooling the energy storage system.

FIG. 2 is a flowchart showing a method of controlling an electrically powered vehicle having an energy storage system.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the invention, as defined by the appended claims.

Referring to the Figures, wherein like numerals indicate like parts, an electric vehicle is generally shown at 20. The electric vehicle 20 may include, but is not limited to, a fully electric vehicle 20, a hybrid electric vehicle 20, an extended range electric vehicle 20, or some other form of vehicle 20 powered by, at least part of the time, electrical energy.

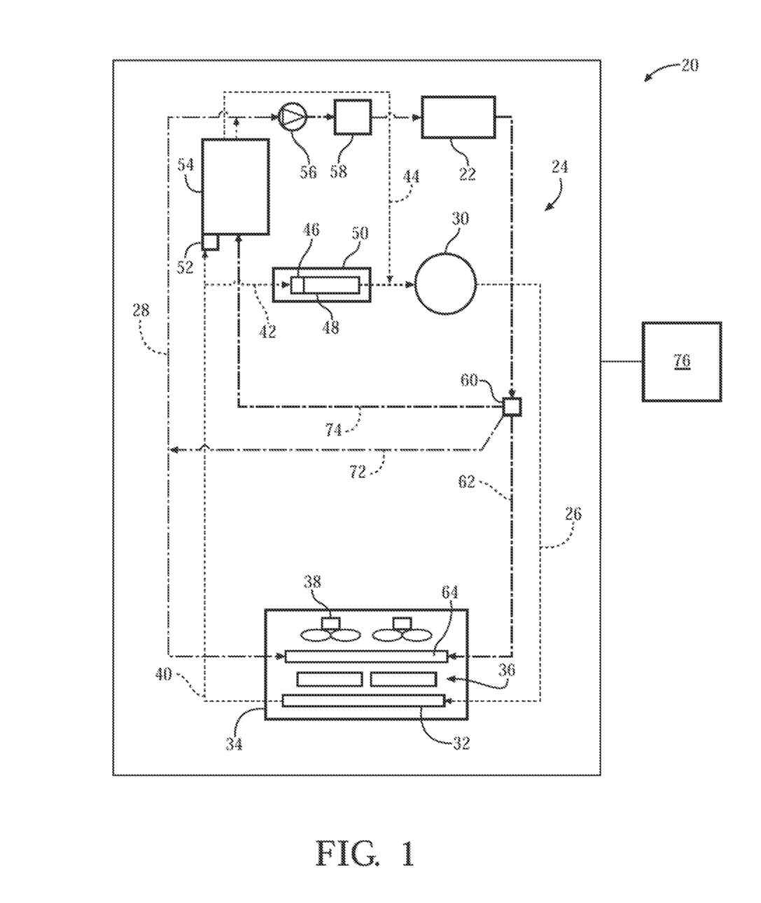

Referring to FIG. 1, the vehicle 20 includes an energy storage system 22 operable to store the electrical energy. The energy storage system 22 may include, but is not limited to, a high voltage battery pack or other similar device. The energy storage system 22 may include any system suitable for use in the vehicle 20 and capable of storing electrical energy and discharging electrical energy to power the vehicle 20. The energy storage system 22 may be rechargeable via an electrical connection with a power outlet, and/or via an on-board charging system.

The vehicle 20 further includes a thermal conditioning system 24 that is operable to heat and/or cool the energy storage system 22. The thermal conditioning system 24 shown in FIG. 1 is merely exemplary. Accordingly, it should be appreciated that the vehicle 20 and the thermal conditioning system 24 may be configured differently, and include different components than described below relative to the exemplary embodiment of the thermal conditioning system 24. As shown in FIG. 1, the thermal conditioning system 24 includes a refrigerant loop 26 and a coolant loop 28. The refrigerant loop 26 includes a refrigerant compressor 30 and a condenser 32, which may be part of a condenser, radiator, fan module (CRFM 34). The CRFM 34 may include other heat exchangers 36 and fans 38 used to cool fluids from other vehicle 20 systems.

The condenser 32 directs refrigerant into a refrigerant line 40 that splits into a Heating Ventilation Air Conditioning (HVAC) leg 42 and a chiller leg 44 of the refrigerant loop 26. The HVAC leg 42 directs the refrigerant through an expansion device 46 and into an evaporator 48, which is located in a HVAC module 50. Refrigerant exiting the evaporator 48 may be directed back to the refrigerant compressor 30.

The chiller leg 44 directs the refrigerant through an expansion device 52 and then through a chiller 54 (refrigerant-to-coolant heat exchanger). Refrigerant exiting the chiller 54 is directed back to the refrigerant compressor 30.

The chiller 54 is also in fluid communication with the coolant loop 28. The dashed lines in FIG. 1 represent lines through which refrigerant flows, while the dash-dot lines in FIG. 1 represent lines through which a coolant liquid flows. The coolant liquid may be a conventional liquid mixture such as an ethylene glycol and water mix, or may be some other type of liquid with suitable heat transfer characteristics.

The coolant loop 28 includes a coolant pump 56 that pumps the coolant through the loop and is controllable to vary the flow rate of the coolant flowing through the loop. The coolant loop 28 is in fluid communication with the energy storage system 22, and includes an electric coolant heater 58. The coolant flowing through the energy storage system 22 is used to cool or warm the energy storage system 22 as needed. The electric coolant heater 58 can be activated to heat the coolant flowing through it in order to provide warming to the energy storage system 22.

A four port variable coolant routing valve 60 is located in the coolant loop 28 and can be selectively actuated to direct the coolant through three different branches of the coolant loop 28. A first branch 62 includes an energy storage system (ESS) radiator 64, which is positioned to have air flowing through it. A second branch 72 forms a coolant bypass line where the coolant does not flow through the ESS radiator 64 or the chiller 54. A third branch 74 directs the coolant through the chiller 54. All three branches join together to direct the coolant back through the energy storage system 22.

While the exemplary thermal conditioning system 24 is described herein as including a liquid cooled system, it should be appreciated that the thermal conditioning system 24 may include some other system, such as an air cooled system.

The thermal conditioning system 24 further includes a control module 76, and may further include various temperature and pressure sensors to provide input to the control module 76, and to control the various elements of the HVAC and thermal conditioning system 24.

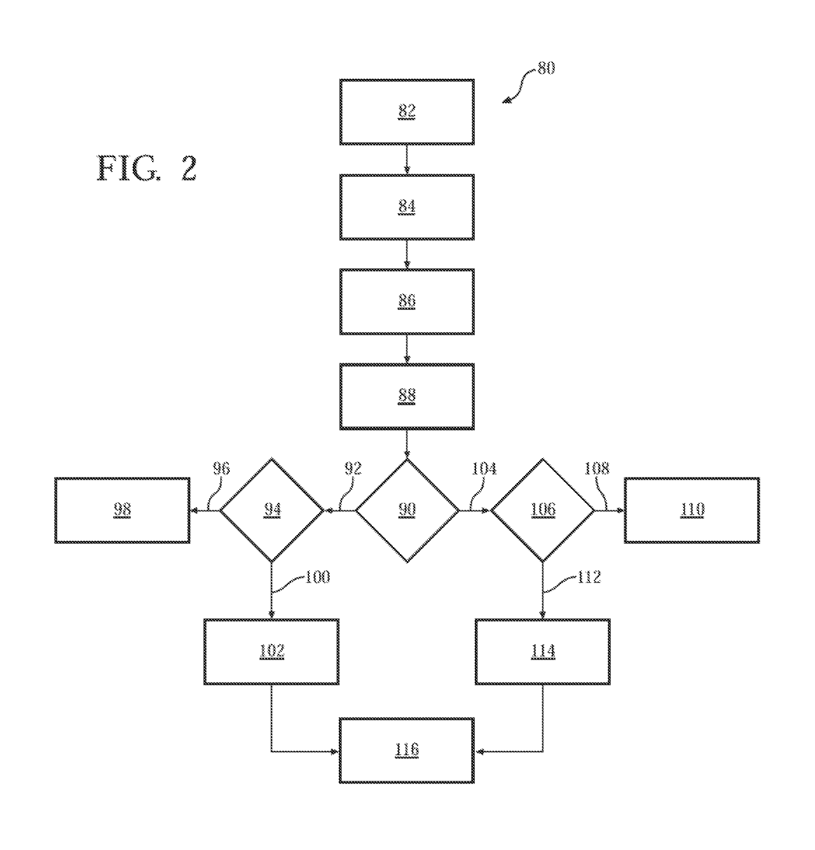

The control module 76 controls the operation of the thermal conditioning system 24. The control module 76 may include a computer and/or processor, and include all software, hardware, memory, algorithms, connections, sensors, etc., necessary to manage and control the operation of the thermal conditioning system 24. As such, a method, described below and generally shown in FIG. 2 at 80, may be embodied as a program operable on the control module 76. It should be appreciated that the control module 76 may include any device capable of analyzing data from various sensors, comparing data, making the necessary decisions required to control the operation of the thermal conditioning system 24, and executing the required tasks necessary to control the operation of the thermal conditioning system 24.

The method includes providing the control module 76 that is operable to control the operation of the thermal conditioning system 24. As noted above, the control module 76 includes all software, hardware, memory, algorithms, connections, sensors, etc. necessary to manage and control the operation of the thermal conditioning system 24. The control module 76 is operable to perform the various tasks of the method described below.

Referring to FIG. 2, the method includes defining, generally indicated by box 82, a default thermal conditioning temperature setpoint for the energy storage system 22. The default thermal conditioning temperature setpoint is the temperature that the thermal conditioning system 24 maintains the energy storage system 22. The default thermal conditioning temperature setpoint is defined based on an estimated average usage of a typical vehicle 20. Accordingly, the default thermal conditioning temperature setpoint is not specific to any one vehicle 20, but rather is a generic setting. The default thermal conditioning temperature setpoint may include different values for different operating conditions. For example, the default thermal conditioning temperature setpoint may include one value for non-driving conditions, another value for driving conditions, another value for plug-in charging conditions, and yet another value for charging while driving conditions, etc. While the thermal conditioning temperature setpoint may include different values for different situations, it should be appreciated that each of these different values are pre-defined, and are based on the estimated average usage of a typical vehicle 20 as noted above. While the written description below discusses adjusting only a single value of the default thermal conditioning temperature setpoint, it should be appreciated that the below described method may be applied to each different setpoint for the different operating conditions. In other words, the below described method may be applied to each of the different thermal conditioning temperature setpoints for non-driving conditions, driving conditions, plug-in charging conditions, charging while driving conditions, etc.

A vehicle operator may select a pre-defined alternative thermal conditioning temperature setpoint to satisfy their personal preferences. For example, the operator may select a first alternative thermal conditioning temperature setpoint to maximize an available vehicle 20 drive range from power supplied by the energy storage system 22, or may select a second alternative thermal conditioning temperature setpoint to minimize vehicle 20 driving costs. The different pre-defined alternative thermal conditioning temperature setpoints are saved in the memory of the control module 76, and may be selected as a replacement to the default thermal conditioning temperature setpoint. As noted above, the default thermal conditioning temperature setpoint is based on the average usage of a typical vehicle 20, and as such does not necessarily optimize either the electric vehicle range or the cost efficiency of the vehicle 20, but rather provides an average value that is presumably suitable for most users. However, some vehicle operators may find it more important to optimize or maximize the electric vehicle range, or may wish to limit wall energy usage, e.g., energy from a wall outlet to charge the energy storage system 22 or to thermally condition the energy storage system 22, to reduce total vehicle operating costs. In such circumstances, the vehicle operator may select one of the pre-defined alternative thermal conditioning temperature setpoints that more accurately reflects the values of the vehicle operator. It should be appreciated that the control module 76 may include other pre-defined alternative thermal conditioning temperature setpoints defined to maximize some other performance criteria.

The vehicle operator may further select an “auto-learn” feature, generally indicated by box 84, which adjusts the default thermal conditioning temperature setpoint based on the actual historical usage of that specific vehicle 20. Accordingly, the auto-learn feature optimizes the thermal conditioning temperature setpoint for the specific environmental and driving conditions of that vehicle 20.

In order to implement the auto-learn feature, the control module 76 monitors different vehicle operating conditions over time, generally indicated by box 86. The different vehicle operating conditions may include but are not limited to, a temperature of the energy storage system 22 while driving under power from the energy storage system 22 or while driving under power from a different power source, a temperature of the energy storage system 22 while the vehicle 20 is not driving, a temperature of the energy storage system 22 while charging, an ambient air temperature, a driving distance, a driving speed, different charging conditions, usage of an internal combustion engine, etc. Furthermore, all of these different vehicle operating conditions may be linked and tracked by time and date.

The control module 76 identifies historical vehicle operating trends, generally indicated by box 88, from the monitored vehicle operating conditions. Accordingly, from the monitored vehicle operating conditions, the control module 76 may determine different operating trends for that specific vehicle 20. For example, the control module 76 may determine an average ambient air temperature and an average energy storage system 22 temperature during a specific month, or may calculate an average daily drive distance. The control module 76 may further calculate an estimated vehicle 20 drive range based on available power from the energy storage system 22 operating at the default thermal conditioning temperature setpoint. The estimated vehicle 20 drive range is the estimated distance the vehicle 20 may drive under available energy from the energy storage system 22, with the energy storage system 22 operating at a temperature within a temperature range defined by a heating setpoint, e.g., 10° C., and a cooling setpoint, e.g., 30° C. It should be appreciated that the control module 76 may identify and/or calculate any number of historical trends from the data, and that the examples provided are merely exemplary, and should not be interpreted as limiting.

The control module 76 may identify an average ambient weather condition in which the vehicle 20 operates, and then classify the average ambient weather condition. For example, the control module 76 may compare the average ambient weather condition to a hot weather threshold temperature and/or a cold weather threshold temperature. The hot weather threshold temperature and the cold weather threshold temperature may be defined to include any temperature indicating generally hot weather operation or cold weather operation respectively. If the average ambient weather condition is below the cold weather threshold temperature, then the control module 76 may classify the average ambient weather condition as a cold weather condition, and adjust the default thermal conditioning temperature setpoint accordingly. If the average ambient weather condition is above the hot weather threshold temperature, then the control module 76 may classify the average ambient weather condition as a hot weather condition, and adjust the default thermal conditioning temperature setpoint accordingly. Alternatively, if the average ambient weather condition is between the cold weather threshold temperature and the hot weather threshold temperature, then the control module 76 may classify the average ambient weather condition as a moderate weather condition, and adjust the default thermal conditioning temperature setpoint accordingly.

The default thermal conditioning temperature setpoint for the energy storage system 22 is adjusted to define an adjusted thermal conditioning temperature setpoint. As noted above, the default thermal conditioning temperature setpoint is adjusted based on the identified historical vehicle operating trends to optimize performance of the energy storage system 22 for the historical vehicle operating trends. For example, the control module 76 may determine, generally indicated by box 90, if the average non-driving temperature of the energy storage system 22 is less than the cold weather threshold, i.e., the vehicle 20 generally operates in the cold weather condition. If the control module 76 determines that the average non-driving temperature of the energy storage system 22 is less than the cold weather threshold, generally indicated at 92, then the control module 76 may determine if an estimated electric vehicle 20 drive range from power supplied by the energy storage system 22 is less than the average daily drive distance of the vehicle 20, generally indicated by box 94. If the control module 76 determines that the estimated electric vehicle 20 drive range from power supplied by the energy storage system 22 is greater than the average daily drive distance of the vehicle 20, generally indicated at 96, then the default thermal conditioning setpoint may not be adjusted, generally indicated by box 98. However, if the control module 76 determines that the estimated electric vehicle 20 drive range from power supplied by the energy storage system 22 is less than the average daily drive distance of the vehicle 20, generally indicated at 100, then the value of the default thermal conditioning temperature setpoint may be increased to define the adjusted thermal conditioning temperature setpoint, generally indicated by box 102, so that the energy storage system 22 operates at an increased temperature.

It is known that the amount of available energy stored in the energy storage system 22 decreases with a decrease in temperature of the energy storage system 22. Increasing the thermal conditioning temperature threshold increases the operating temperature of the energy storage system 22, which increases the range of the vehicle 20 when operating from power supplied by the energy storage system 22. It should be appreciated that increasing the operating temperature of the energy storage system 22 in cold weather conditions by increasing the default thermal conditioning temperature setpoint increases the range of the vehicle 20 from power supplied by the energy storage system 22 at a cost of increased wall energy, or increased energy from another power source, such as 12V system of the vehicle 20.

If the control module 76 determines that the average non-driving temperature of the energy storage system 22 is greater than the cold weather threshold, generally indicated at 104, then the control module 76 may determine if the average non-driving temperature of the energy storage system 22 is greater than the hot weather threshold or that the average driving temperature of the energy storage system 22 is less than a preferred operating temperature threshold, generally indicated by box 106. If the control module 76 determines that the average non-driving temperature of the energy storage system 22 is less than the hot weather threshold, or that the average driving temperature of the energy storage system 22 is less than a preferred operating temperature threshold, generally indicated at 108, then the default thermal conditioning setpoint may not be adjusted, generally indicated by box 110. If the control module 76 determines that the average non-driving temperature of the energy storage system 22 is greater than the hot weather threshold, or that the average driving temperature of the energy storage system 22 is greater than a preferred operating temperature threshold, generally indicated at 112, then the control module 76 may decrease the default thermal conditioning temperature setpoint to define the adjusted thermal conditioning temperature setpoint, generally indicated by box 114, so that the energy storage system 22 operates at a decreased temperature.

It is known that the expected life of the energy storage system 22 decreases with an increase in the operating temperature of the energy storage system 22. As such repeated operation of the energy storage system 22 at elevated temperatures may reduce the effective life of the energy storage system 22. Accordingly, if the historical trends of the vehicle 20 indicate that the vehicle 20 generally operates in a hot weather condition, or if the driving trends cause the temperature to rise above the preferred operating temperature threshold, then the expected life of the energy storage system 22 may be reduced. In order to maximize the expected life of the energy storage system 22, the default thermal conditioning temperature setpoint decreases so that the operating temperature of the energy storage system 22 also decreases, which increases the expected life of the energy storage system 22.

Once the default thermal conditioning temperature setpoint is adjusted to define the adjusted thermal conditioning temperature setpoint, then the control module 76 may engage the thermal conditioning system 24, generally indicated by box 116. The thermal conditioning system 24 is engaged to thermally condition the energy storage system 22, i.e., to heat or cool the energy storage system 22 as required to approximately align an actual temperature of the energy storage system 22 with the adjusted thermal conditioning temperature setpoint. It should be appreciated that the thermal conditioning system 24 may not align the actual temperature of the energy storage system 22 exactly with the adjusted thermal conditioning temperature setpoint, but rather bring the actual temperature of the energy storage system 22 within an allowable temperature range of the adjusted thermal conditioning temperature setpoint.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A method of controlling an electrically powered vehicle having an energy storage system, the method comprising:
monitoring vehicle operating conditions over time;
identifying historical vehicle operating trends from the monitored vehicle operating conditions; and
adjusting a default thermal conditioning temperature setpoint for the energy storage system to define an adjusted thermal conditioning temperature setpoint based on the identified historical vehicle operating trends to optimize performance of the energy storage system based upon the historical vehicle operating trends.

2. A method as set forth in claim 1 further comprising defining a default thermal conditioning temperature setpoint for the energy storage system based on an estimated average vehicle usage.

3. A method as set forth in claim 2 wherein identifying historical vehicle operating trends includes identifying an average ambient weather condition in which the vehicle operates.

4. A method as set forth in claim 3 wherein identifying the average ambient weather condition in which the vehicle operates includes classifying the average ambient weather condition in which the vehicle operates as one of a hot weather condition, a moderate weather condition, or a cold weather condition.

5. A method as set forth in claim 2 wherein identifying historical vehicle operating trends includes identifying an average non-driving temperature of the energy storage system.

6. A method as set forth in claim 5 wherein identifying historical vehicle operating trends includes identifying an average daily drive distance of the vehicle.

7. A method as set forth in claim 6 further comprising calculating an estimated vehicle drive range based on available energy from the energy storage system operating at a temperature within a temperature range bounded by a heating setpoint and a cooling setpoint.

8. A method as set forth in claim 7 wherein adjusting the default thermal conditioning temperature setpoint to define the adjusted thermal conditioning temperature setpoint is further defined as increasing the value of the default thermal conditioning temperature setpoint to define the adjusted thermal conditioning temperature setpoint so that the energy storage system operates at an increased temperature when the average non-driving temperature of the energy storage system is less than a cold weather threshold, and the estimated vehicle drive range is less than the average daily drive distance of the vehicle.

9. A method as set forth in claim 5 wherein adjusting the default thermal conditioning temperature setpoint to define the adjusted thermal conditioning temperature setpoint is further defined as decreasing the value of the default thermal conditioning temperature setpoint to define the adjusted thermal conditioning temperature setpoint so that the energy storage system operates at a decreased temperature when the average non-driving temperature of the energy storage system is greater than a hot weather threshold.

10. A method as set forth in claim 2 wherein identifying historical vehicle operating trends includes identifying an average driving temperature of the energy storage system.

11. A method as set forth in claim 10 wherein adjusting the default thermal conditioning temperature setpoint to define the adjusted thermal conditioning temperature setpoint is further defined as decreasing the value of the default thermal conditioning temperature setpoint to define the adjusted thermal conditioning temperature setpoint so that the energy storage system operates at a decreased temperature when the average driving temperature of the energy storage system is greater than an operating temperature threshold.

12. A method as set forth in claim 1 further comprising thermally conditioning the energy storage system to align an actual temperature of the energy storage system with the adjusted thermal conditioning temperature setpoint.

13. A method as set forth in claim 1 wherein the energy storage system includes a rechargeable energy storage system.

14. A method as set forth in claim 1 further comprising selecting a pre-defined alternative thermal conditioning temperature setpoint.

15. A method as set forth in claim 14 wherein selecting a pre-defined alternative thermal conditioning temperature setpoint is further defined as selecting a first alternative thermal conditioning temperature setpoint to maximize an available vehicle drive range from power supplied by the energy storage system.

16. A method as set forth in claim 14 wherein selecting a pre-defined alternative thermal conditioning temperature setpoint is further defined as selecting a second alternative thermal conditioning temperature setpoint to minimize vehicle driving costs.

17. A vehicle comprising:
an energy storage system operable to store electrical energy;
a thermal conditioning system coupled to the energy storage system and operable to heat and cool the energy storage system;
a control module coupled to the thermal conditioning system and operable to control the thermal conditioning system, wherein the control module is configured for:
monitoring vehicle operating conditions over time;
identifying historical vehicle operating trends from the monitored vehicle operating conditions;
adjusting a default thermal conditioning temperature setpoint for the energy storage system to define an adjusted thermal conditioning temperature setpoint based on the identified historical vehicle operating trends to optimize performance of the energy storage system based upon the historical vehicle operating trends; and
thermally conditioning the energy storage system with the thermal conditioning system to align an actual temperature of the energy storage system with the adjusted thermal conditioning temperature setpoint.

18. A vehicle as set forth in claim 17 wherein the control module increases the value of the default thermal conditioning temperature setpoint to define the adjusted thermal conditioning temperature setpoint so that the energy storage system operates at an increased temperature when an average non-driving temperature of the energy storage system is less than a cold weather threshold, and an estimated vehicle drive range based on available power from the energy storage system operating at the default thermal conditioning temperature setpoint is less than an average daily drive distance of the vehicle.

19. A vehicle as set forth in claim 17 wherein the control module decreases the value of the default thermal conditioning temperature setpoint to define the adjusted thermal conditioning temperature setpoint so that the energy storage system operates at a decreased temperature when an average non-driving temperature of the energy storage system is greater than a hot weather threshold.

20. A vehicle as set forth in claim 17 wherein the control module decreases the value of the default thermal conditioning temperature setpoint to define the adjusted thermal conditioning temperature setpoint so that the energy storage system operates at a decreased temperature when an average driving temperature of the energy storage system is greater than an operating temperature threshold.
